(19) United States
(12) Patent Application Publication
(10) Pub. No.: US 2008/0248921 A1
(43) Pub. Date: Oct. 9, 2008

(54) Apparatus for operating a motor vehicle

(76) Inventor: Johann Rempler, Filderstadt (DE)

Correspondence Address: KLAUS J. BACH, 4407 TWIN OAKS DRIVE, MURRYSVILLE, PA, 15668, US

(21) Appl. No.: 12/150,350

(22) Filed: Apr. 25, 2008

Related U.S. Application Data
(63) Continuation-in-part of application No. PCT/EP2006/009845, filed on Oct. 12, 2006.

(30) Foreign Application Priority Data
Oct. 27, 2005 (DE) 10 2005 051 437.5

(51) Int. Cl. F16D 48/06

(52) U.S. Cl. 477/74

(57) ABSTRACT

In an apparatus and method for operating a motor vehicle having a driver request detection means for a predefined value of a set point driving speed, a brake device with brake pressure detection means, a driving speed detection means for detecting an actual driving speed, and a control unit for controlling operation of the vehicle, means are provided for triggering a safety reaction of the control unit if a detected actual driving speed is below a defined stationary state limit value, and the predefined speed request value and the brake pressure simultaneously exceed limit values assigned to them in order to prevent operation of the motor vehicle in a way that may cause damage to the motor vehicle drive components.

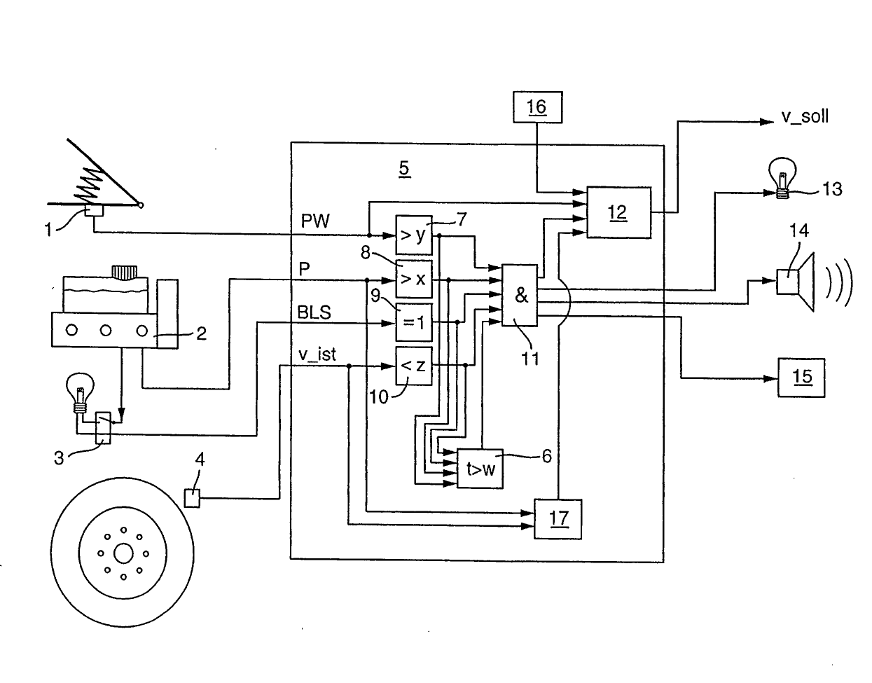

This is a Continuation-In-Part application of pending International patent application PCT/EP2006/009845 filed Oct. 12, 2006 and claiming the priority of German patent application 10 2005 051 437.5 filed Oct. 27, 2005.

### BACKGROUND OF THE INVENTION

The invention relates to an apparatus for operating a motor vehicle including a drivers demand detection means, a vehicle speed sensor, a control unit and a braking device, and to a method for operating the vehicle the features of the preamble of claim 10.

EP 0 687 604 B1 discloses a method for operating a vehicle. The motor vehicle has a service brake device, a parking brake device and an automatic transmission and a drive motor. The activation of the parking brake device, the current driving speed, the position of the accelerator pedal and the activation of the service brake device are fed to a control unit as input signals. The parking brake device can be activated or deactivated by means of the control unit in accordance with defined conditions. The method is used to assist the start out process, and the apparatus is used as a starting aid.

It is the object of the present invention to prevent has the object of preventing a motor vehicle operating in a way that could cause damage to the vehicle.

### SUMMARY OF THE INVENTION

In an apparatus and method for operating a motor vehicle having a driver request detection means for a predefined value of a set point driving speed, a brake device with brake pressure detection means, a driving speed detection means for detecting an actual driving speed, and a control unit for controlling operation of the vehicle, means are provided for triggering a safety reaction of the control unit if a detected actual driving speed is below a defined stationary state limit value, and the predefined speed request value and the brake pressure simultaneously exceed limit values assigned to them in order to prevent operation of the motor vehicle in a way that may cause damage to the motor vehicle drive components.

It is possible herein to detect if simultaneous and strong activation of a brake device and of a driver request detection means (for example an accelerator pedal) occurring in the stationary state of the motor vehicle. Such an operation of the motor vehicle is also referred to as a racing start.

For example, for a racing start the brake pedal and the accelerator pedal are activated fully at the same time when the motor vehicle is in a stationary state. Then the engine is rotating at approximately 2800 rpm up to the stall rotational speed of the automatic transmission. The driver then releases the brake with the accelerator pedal fully activated and the motor vehicle accelerates quickly out of the stationary state. The associated sudden generation of torque causes the drive train and the vehicle tires to be greatly loaded. This can lead to damage to a differential, an automatic transmission and/or to card an shafts or drive shafts as well as to the tires of the vehicle. This imminent damaging operating state of the motor vehicle is detected according to the invention and triggers a safety reaction. The safety reaction makes the driver aware of the risk and/or reduces the loading on the drive train and tires of the vehicle in order to prevent the drive train components from being damaged.

In one embodiment, an acoustic signal transmitter can be activated as a safety reaction of the control unit. The driver's attention is in this way drawn to a damaging operating mode of the motor vehicle and he can shut down this mode. Likewise, other road users can be warned in this way, for example by means of a horn.

Also, a visual signal transmitter can be activated as a safety reaction of the control unit. The driver's attention is drawn visually to a damaging operating mode of the motor vehicle and he can shut down this mode. Likewise, other road users can be warned in this way, for example by means of flashing hazard warning lights.

In another embodiment, a setpoint driving speed which is assigned to the predefined value can be reduced as a safety reaction of the control unit. As already mentioned, simultaneous and strong activation of the driver request detection means and brake device loads the drive train of the motor vehicle and its tires. If the setpoint driving speed is reduced, the loading on the drive train and tires also decreases. Damage can be prevented.

The safety reaction of the control unit can be terminated or cancelled when the brake device has been relieved of loading by a predefined amount, and the detected actual driving speed exceeds a limit value. When the brake device is released, the motor vehicle can start to roll and the stressing of the drive train and tires is returned to a normal amount. The damaging operating mode of the motor vehicle is ended. The advantage of this embodiment is that, when the damaging operating state ends, the safety reactions are also ended. An acoustic or visual signal transmitter is switched off again. As a result, possible distraction of the driver from the road traffic by the visual and acoustic warning signals is eliminated.

In one embodiment, a setpoint driving speed which is assigned to the predefined value can be increased by the control unit. The reduction in the setpoint driving speed which is assigned to the predefined value is reversed. This prevents the motor vehicle from reacting in the customary way to an activation of the driver request detection means with a relatively low driving speed after a racing start.

The set point driving speed increases more quickly if a traction controller is switched on than if the traction controller is switched off. As a result, the speed of the increase can be adapted in an optimum way to the driving conditions of the motor vehicle. As a result, disruption in the driving behavior which can be caused by an excessively fast increase in the setpoint driving speed (for example spinning wheels) can be avoided.

Preferably, a readable diagnostic memory in which information about a safety reaction can be stored is provided. As a result it can be detected whether or not the vehicle was subjected to damaging operating conditions. By means of the readable diagnostic memory, the owner of the vehicle or an employee of a service facility can find out whether the motor vehicle has been operated in an unauthorized operating mode. As a result, detected damage can be shown to be the result of a damaging operation of the motor vehicle. Likewise, on the basis of the information about a damaging operating mode of the motor vehicle, it is possible to search for and eliminate damage selectively and avoid consequential damage.

In one embodiment, the safety reaction of the control unit can be triggered only if, over a predefined time period, the detected driving speed drops below a defined stationary state limit value, and the predefined value of the setpoint driving speed and the brake pressure each simultaneously exceed a limit value assigned to them. This prevents a brief simultaneous activation of driver request detection means and brake device from already triggering a safety reaction.

The invention will become more readily apparent from the following description of a particular embodiment of the invention with reference to the accompanying drawing.

### BRIEF DESCRIPTION OF THE DRAWING

The sole FIGURE shows schematically an embodiment of the apparatus according to the invention.

### DESCRIPTION OF A PARTICULAR EMBODIMENT

The illustrated embodiment includes a control unit 5 which is connected to a driver request detection means 1 in the form of an accelerator pedal, a brake device 2, a brake light switch 3 and a driving speed detection means 4.

The control unit 5 detects, in a speed comparator 7, a predefined value PW which is detected by a driver request detection means 1. This driver request detection means 1 is embodied, for example, as an accelerator pedal with a sensor for detecting the predefined value PW. However, said driver request detection means 1 may also be a joystick or a manual accelerator lever or the like.

In the speed comparator 7 of the control unit 5 it is determined whether the predefined value PW exceeds a limit value y which is assigned to it. For example, the limit value y may correspond to a pedal position value of a pedal which is activated, for example, to 60%. The device 7 supplies a signal to a control device 11 if the predefined value PW exceeds the limit value y which is assigned to it.

The control unit 5 detects in a brake pressure comparator 8 a brake pressure p of a brake device 2. In the illustrated embodiment, a pilot pressure of a master brake cylinder is detected. The brake pressure can, however, also be detected at the wheel brake cylinders, at a brake pedal or at similarly suitable components. It is also possible to detect the activation of a parking brake.

In the brake pressure comparator 8 of the control unit it is detected whether the brake pressure p exceeds a limit value x. For example, the limit value x can correspond to a pressure of 40 bar. The sensor 8 supplies a signal to the control device 11 if the brake pressure p exceeds the limiting value x.

The control unit 5 detects an actual vehicle speed v_ist by a vehicle speed detector 4 and supplied a corresponding signal to a speed comparator 10. The illustrated actual vehicle speed detector 4 detects a rotating speed of a vehicle wheel. The actual vehicle speed v_ist can, however, also be detected at a transmission, a drive shaft or similarly suitable components and/or come from a data bus.

In the speed comparator 10 of the control unit 5 it is determined whether the detected actual vehicle speed v_ist drops below a defined stationary state limit value z. For example, the limiting value z can correspond to a vehicle speed of 0 km/h. However, small rolling movements forward or backward may be permitted. The speed comparator 10 transmits a signal to the control device 11 if the actual driving speed v_ist drops below a limit value z.

In a particularly simple refinement of the invention, the control device 11 detects whether it receives a signal from each of the comparators 7, 8 and 10. If this is the case, the conditions for a racing start are present and the control device 11 activates one or more of the safety reactions which are associated with the devices 12, 13, 14 and 15.

In a further refinement of the invention, the control unit 5 detects, in an evaluation device 6, the period of time t for which the conditions required by the control device 11 apply. For this purpose, the evaluation device 6 receives the output signals from the comparators 7, 8, 10.

Alternatively, this information about the presence of the conditions which are required by the device 11 to be activated can also be passed on by the control device 11 to the evaluation device 6.

The evaluation device 6 outputs a signal to the control device 11 if a time period t exceeds a value w. If this is the case, the required conditions for a safety reaction are present and the control device 11 acts on one or more warning or limiting devices 12, 13, 14, 15.

In the embodiment illustrated in the FIGURE, the control unit 5 also detects a signal of a brake light switch 3 in a switching sensor 9. In this context, a signal (=1) is present if the brake light switch 3 is activated and no signal (=0) is present if the brake light switch 3 is not activated.

In the switching sensor 9 of the control unit 5 it is detected whether a signal is present (=0). The switching sensor 9 forwards a signal to the device 11 if it receives a signal from the brake light switch 3.

The devices 6, 7, 8, 9 and 10 can be integrated into the control device 11. As a result, a saving in terms of components is achieved and data paths are shortened.

In the illustrated embodiment, the control device 11 detects whether it receives a signal from each of the devices 6, 7, 8, 9 and 10. If this is the case, the required conditions for a possibly damage causing driver behavior, that is a racing start, are present. The control device 11 then activates one or more devices 12, 13, 14, 15 as a safety reaction.

The control device 11 may activate a visual signal transmitter 13 as a safety reaction of the control unit 5. For example, monitoring lights (for example combination lights) or interior lighting of the motor vehicle are switched on or to a flashing function.

The control device 11 may also activate an acoustic signal transmitter 14 as a safety reaction of the control unit 5. For example, a voice output is provided or a horn, a buzzer or some other warning sound generator is switched to a continuous sound or successive individual sounds.

A detecting device 12 may be provided in the control unit 5 which receives a predefined value PW of the driver request detection means 1 and converts it into a setpoint driving speed v_soll which is output by the control unit 5.

The control device 11 outputs a signal to a detecting device 12 as a safety reaction of the control unit 5. If this signal is present at the detecting device 12, the detecting device 12 reduces the value for the setpoint driving speed v_soll which is assigned to the predefined value PW. This reduction in the setpoint driving speed v_soll is typically carried out over a time ramp of approximately 0.5 sec. For example, a setpoint driving speed v_soll which is reduced by 20% is assigned to the predefined value PW.

In the illustrated exemplary embodiment, the safety reactions of the devices 12, 13 and 14 are carried out simultaneously. However, it is also possible to provide just one or two of the proposed safety reactions.

The triggering of a safety reaction by the control device 11 of the control unit 5 is stored in a diagnostic memory 15. Said diagnostic memory 15 can be read.

In the illustrated embodiment, the safety reactions are ended if the brake device 2 has been relieved of loading by a predefinable amount and the detected driving speed v_ist exceeds a start out limit value which is assigned to it. For this purpose, the brake pressure p of a brake device 2 and the predefined value PW of a driver request detection means 1 are detected in a driver request detector 17. This driver request detector 17 outputs a signal to the detecting device 12 if the conditions for ending the safety reaction are met.

In this context, the driver request detector 17 can be integrated into the control device 11.

If the detecting device 12 receives a signal from the driver request detector 17, the detecting device 12 again cancels the reduction which has been made in the setpoint driving speed v_soll which is assigned to the predefined value PW. To do this it increases the setpoint driving speed v_soll which is assigned to the predefined value PW.

In the illustrated embodiment, the motor vehicle has a traction controller 16 whose operating state is passed on to the device 12 by means of a signal. The set-point driving speed v_soll is increased more quickly if the traction controller 16 is switched on. Correspondingly, the set-point driving speed v_soll increases more slowly if the device 12 receives, from the traction controller 16, the signal indicating that the traction controller 16 is switched off. For example, the increase lasts several seconds longer when the traction controller 16 is switched off than when the traction controller 16 is switched on.

What is claimed is:

1. An apparatus for operating a motor vehicle, having
a driver request detection means (1) for a predefined value (PW) of a setpoint driving speed (v_soll) of the motor vehicle,
a brake device (2) with a brake pressure detection comparator (8),
a driving speed sensor (4) for sensing an actual driving speed (v_ist) of the motor vehicle,
a control unit (5), and
means for triggering a safety reaction of the control unit (5) under the conditions that
the detected actual driving speed (v_ist) drops below a defined stationary state limit value (z), and
the predefined value (PW) requested by the driver and the brake pressure (p) simultaneously exceed a limit value (y, x) which is assigned to them.

2. The apparatus as claimed in claim 1, including an acoustic signal transmitter (14) which can be activated as a safety reaction of the control unit (5).

3. The apparatus as claimed in claim 1, including a visual signal transmitter (13) which can be activated as a safety reaction of the control unit (5).

4. The apparatus as claimed in one of claims 1, including means for reducing a set-point driving speed (v_soll) which is assigned to the predefined value (PW) as a safety reaction of the control unit (5).

5. The apparatus as claimed in claim 1, wherein means are provided for ending the safety reaction of the control unit (5) if
the brake device (2) has been relieved of loading by a predefined amount, and
the detected actual driving speed (v_ist) exceeds a starting speed limit value which is assigned to it.

6. The apparatus as claimed in claim 5, wherein the control unit 5 includes means for increasing a set-point driving speed (v_soll) which is assigned to the predefined value (PW).

7. The apparatus as claimed in claim 6, wherein means are provided for increasing the set-point driving speed (v_soll) at a faster rate if a traction controller (16) is switched on than if the traction controller (16) is switched off.

8. The apparatus as claimed in claim 1, wherein a readable diagnostic memory (15) is provided in which information about a safety reaction can be stored and which is in communication with the control device (11) for recording all actions indicated by the control device (11).

9. The apparatus as claimed in claim 1, wherein triggering of the safety reaction of the control unit (5) is prevented if, over a predefined time period (w),
the detected actual driving speed (v_ist) drops below a defined stationary state limiting value, and
the predefined value (PW) and the brake pressure (p) each simultaneously exceed a limit value assigned to them.

10. A method for operating a motor vehicle, comprising the steps of:
detecting a predefined value (PW) for a setpoint driving speed (v_soll),
detecting a brake pressure (p) of a brake device (2),
detecting an actual driving speed (v_ist), and
supplying the detected data (PW, p, v_ist) to a control unit (5) for triggering a safety reaction if:
the detected actual driving speed is below a defined stationary state limit value, and at the same time
the predefined value (PW) and the brake pressure (p) simultaneously exceed a limit value assigned to them.
